(19) United States
(12) Patent Application Publication
(10) Pub. No.: US 2007/0263408 A1
(43) Pub. Date: Nov. 15, 2007

(54) Backlight module and method of making the module

(76) Inventor: Janet Bee Yin Chua, Perak (MY)

Correspondence Address: Kathy Manke;Avago Technologies Limited, 4380 Ziegler Road, Fort Collins, CO, 80525, US

(21) Appl. No.: 11/430,694

(22) Filed: May 9, 2006

(51) Int. Cl. G01D 11/28

(52) U.S. Cl. 362/612; 362/606; 362/627; 362/30

(57) ABSTRACT

A backlight module and method of making the module uses a light panel and a light source device. The light source device includes a substrate on which light-emitting dies are mounted and an encapsulation plate with depressions, which is attached to the substrate such that the depressions are positioned over the light-emitting dies.

### BACKGROUND OF THE INVENTION

In the past, cathode ray tube (CRT) technology was commonly used in electronic display devices. However, CRT technology requires a large volume, and consequently, CRT display devices are large in size. Therefore, many flat panel display technologies have been developed, such as liquid crystal display (LCD), plasma display panel (PDP) and field emission display (FED) technologies. Of these technologies, the LCD technology is attracting attention in the field of full-color display devices.

An LCD display device is a planar display with low power consumption. In comparison with a CRT display device with the same screen size, an LCD display device is much lighter and smaller with respect to space occupation. Furthermore, unlike the curved screen in the CRT display devices, an LCD display device has a planar screen. With these advantages, LCD display devices have been widely used in various products, including palm calculators, electronic dictionaries, watches, mobile phones, notebook computers, communication terminals, display panels and even personal desktop computers.

A typical LCD display device comprises a front-end liquid crystal panel and a back-end backlight module, which provide enough illumination to pass through the liquid crystal panel to show the information on the liquid crystal panel. The backlight device includes a light source and a light guide panel to provide a uniform illumination beneath the liquid crystal panel. The backlight module can be an edge-side type or a direct type. In an edge-side type backlight module, the light source is positioned at a side of the light guide panel. In a direct type backlight module, the light source is positioned below the light guide panel. The light source may be a Cold Cathode Fluorescent Lamp (CCFL) or a light-emitting diode (LED). Generally, a large sized LCD display device uses a CCFL as the light source because the CCFL has inherent advantages over other types of light sources, such as long life span and high illumination efficiency. A small sized LCD display device commonly uses an LED.

Although conventional backlight modules work well for their intended purposes, there is a need for a backlight module with improved luminance uniformity and light efficiency.

### SUMMARY OF THE INVENTION

A backlight module and method of making the module uses a light panel and a light source device. The light source device includes a substrate on which light-emitting dies are mounted and an encapsulation plate with depressions, which is attached to the substrate such that the depressions are positioned over the light-emitting dies. The depressions of the encapsulation plate are designed to scatter the light from the light-emitting dies so that the light is radiated in a wider angle to distribute the light from the light-emitting dies.

A backlight module in accordance with an embodiment of the invention comprises a light panel and a light source device. The light source device is optically coupled to the light panel to transmit light into the light panel. The light source device comprises a substrate, a plurality of light-emitting dies and a transparent encapsulation plate. The light-emitting dies are mounted on the substrate and are configured to generate original light. The transparent encapsulation plate is positioned over the substrate to encapsulate the light-emitting dies. The transparent encapsulation plate includes depressions on a surface facing the light-emitting dies. Each of the depressions is positioned over at least one of the light-emitting dies.

A method of making a backlight module in accordance with an embodiment of the invention comprises forming a transparent encapsulation plate with depressions on a major surface of the plate, mounting light-emitting dies on a substrate, attaching the transparent encapsulation plate to the substrate such that the depressions are positioned over the light-emitting dies mounted on the substrate to form a light source device of the backlight module, and assembling the backlight module with at least one optical component to produce the backlight module.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is an exploded diagram of a backlight module in accordance with an embodiment of the invention.

FIG. 2 is a cross-sectional diagram of a light source device of the backlight module in accordance with an embodiment of the invention.

FIG. 3 is a cross-sectional diagram of the light source device of the backlight module in accordance with alternative embodiment of the invention.

FIGS. 4A-4C are cross-sectional diagrams of a molded encapsulation plate of the light source device in accordance with different alternative embodiments of the invention.

FIG. 5 is an exploded diagram of a backlight module in accordance with another embodiment of the invention.

FIG. 6 is a flow diagram of a method for making a backlight module in accordance with an embodiment of the invention.

### DETAILED DESCRIPTION

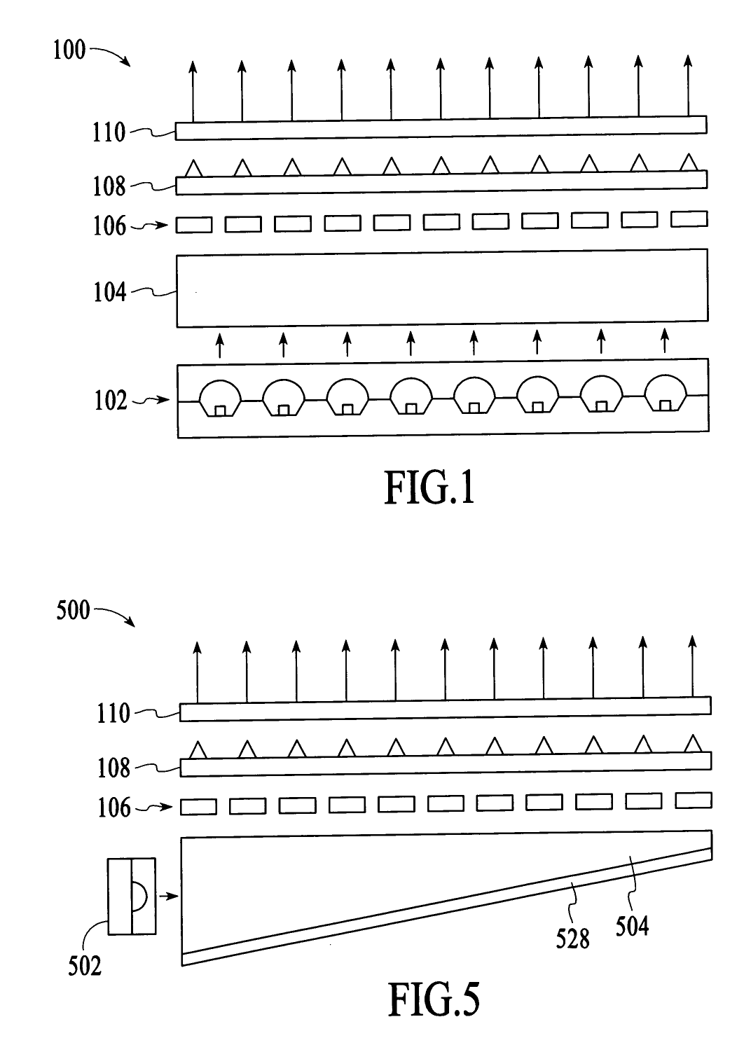

With reference to FIG. 1, a backlight module 100 in accordance with an embodiment of the invention is described. The backlight module 100 operates to provide illumination for a display device, such as a liquid crystal display (LCD). The backlight module 100 can provide illumination with improved luminance uniformity and improved light efficiency compared to conventional backlight modules that use Cold Cathode Fluorescent Lamps (CCFLs). In addition, the backlight module 100 can provide a wide light emitting area for use in large sized display devices. Furthermore, the manufacturing cost of the backlight module 100 is relatively inexpensive when compared to other comparable backlight modules.

In this embodiment, the backlight module 100 is a direct-type backlight module. The components of the backlight module 100 are shown in FIG. 1, which is an exploded diagram of the module. The backlight module 100 includes a light source device 102, a light guide panel 104, a diffusion plate 106, a Brightness Enhancement Film (BEF) 108 and a protective plate 110. The light source device 102 is configured to generate light, which is optically manipulated by the light guide panel 104, the diffusion plate 106 and the BEF 108. The resulting output light is emitted from the protective plate 110 to provide a uniform illumination over a wide area. The light source device 102 is described in more detail below.

The light guide panel 104 is positioned over the light source device 102 to receive the light from the light source device. The light guide panel 104 is configured to distribute the light from the light source device 102 to provide output light over a wide area defined by the light guide panel. The diffusion plate 106 is positioned over the light guide panel 104 to receive the light from the light guide panel. The diffusion plate 106 is configured to diffuse the light from the light guide panel 104 to provide a more uniformly distributed light. The BEF 108 is positioned over the diffusion plate 106 to receive the diffused light from the diffusion plate. The BEF 108 is configured to collect and reflect the diffused light to increase brightness efficiency. In an embodiment, the BEF 108 includes prisms or sawtooth-shaped structures made of resin material formed over a substrate to provide multiple spotlight effects. The protective plate 110 is positioned over the BEF 108 to protect the internal components of the backlight module 100. The output light of the backlight module 100 is emitted from the protective plate 110.

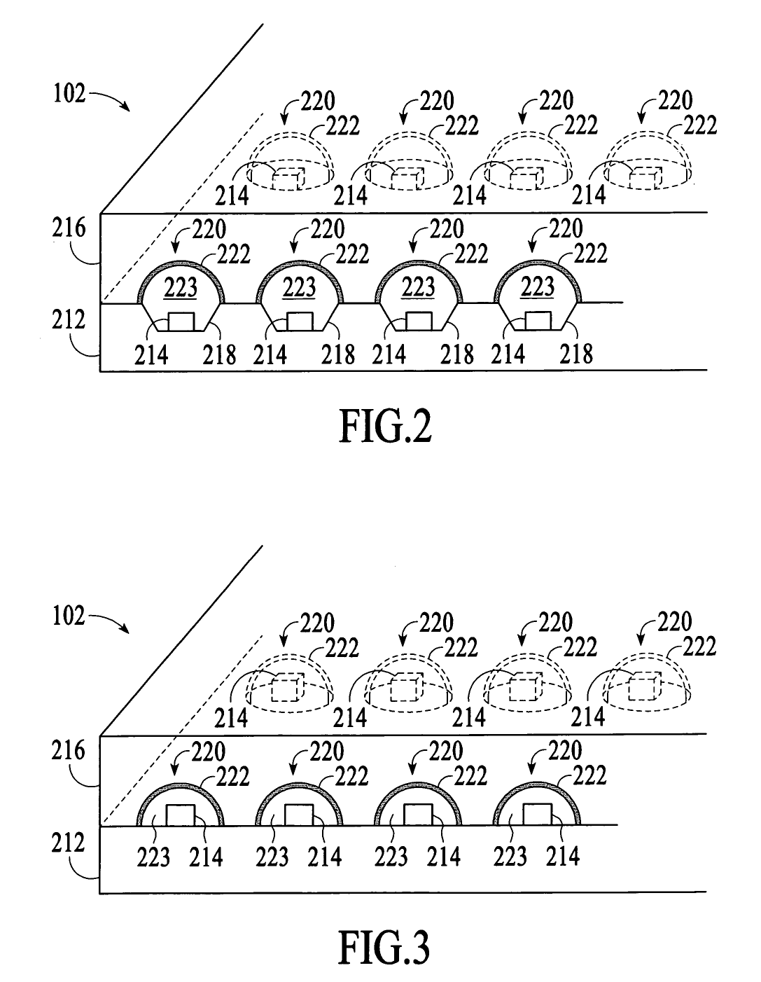

The light source device 102 of the backlight module 100 in accordance with an embodiment of the invention will now be described in detail with reference to FIG. 2, which is a partial cross-sectional view of the light source device. The light source device 102 includes a substrate 212, a number of light-emitting dies 214 and a molded transparent encapsulation plate 216. The light-emitting dies 216 are mounted on the substrate 212. The substrate 212 can be a printed circuit board (PCB), a ceramic substrate or a flexible substrate, depending on the size of the display device for which the backlight module 100 is being used. For an average sized display device (e.g., for laptop computers), a printed circuit board substrate may be used as the substrate 212 for the light source device 102. For a larger sized display device (e.g., for LCD televisions), a ceramic substrate may be used as the substrate 212 for the light source device 102. For a smaller display device (e.g., for mobile phones), a flexible substrate may be used as the substrate 212 for the light source device 102. In this embodiment, the substrate 212 includes reflector cups 218 formed on the upper surface of the substrate, which is the major surface that interfaces with the molded encapsulation plate 216. The reflector cups 218 may include a reflective metallic surface, such as a reflective silver or gold surface. In an alternative embodiment, as illustrated in FIG. 3, the substrate 212 may not include any reflector cups, and thus, has a planar upper surface on which the light-emitting dies 214 are mounted. This planar upper surface of the substrate may have a reflective coating to provide a reflective upper surface.

The light-emitting dies 214 are mounted on the substrate 214 in the reflector cups 218 (if the substrate includes reflector cups). In the embodiment illustrated in FIG. 2, a single light-emitting die 214 is mounted in a single reflector cup 218. However, in other embodiments, multiple light-emitting dies 214 may be mounted in a single reflector cup 218. The light-emitting dies 214 may be light-emitting diode (LED) dies, laser diode dies or other light-emitting semiconductor dies. As an example, the light-emitting dies 214 may include any combination of ultraviolet (UV) LED dies, blue LED dies (peak wavelength of 400-480 nm) and green LED dies (peak wavelength of 485-520 nm). Driving signals to the light-emitting dies 214 are provided using traces or interconnections (not shown) coupled to the substrate 212.

The molded transparent encapsulation plate 216 is positioned over the substrate 212 to encapsulate the light-emitting dies 214 mounted on the substrate. The molded encapsulation plate is made of a transparent material, which can be epoxy, silicone, a hybrid of silicone and epoxy, amorphous polyamide resin or fluorocarbon, glass and/or plastic material. The molded encapsulation plate 216 includes depressions 220 on the lower surface of the plate, which is the surface that faces the light-emitting dies 214 mounted on the substrate 212 and interfaces with the upper surface of the substrate. In this embodiment, the depressions 220 on the lower surface of the molded encapsulation plate 216 are semispherical in shape, as shown in FIG. 2. The semispherical depressions 220 are distributed on the bottom surface of the molded encapsulation plate 216 so that each semispherical depression is positioned over one of the reflector cups 218 of the substrate 212. The circular openings of the semispherical depressions 220 may be similar in size to the circular openings of the reflector cups 218 of the substrate 212 so that the semispherical depressions can be aligned with the reflector cups of the substrate. The semispherical depressions 220 are designed to scatter the light emitted from the light-emitting dies 214 so that the light is radiated in a wider angle to distribute the light from the light-emitting dies.

As shown in FIG. 2, there are wavelength-conversion regions 222 on the surfaces of the semispherical depressions 220. The wavelength-conversion regions 222 include a photoluminescent material, which is used to convert at least some of the light emitted from the light-emitting dies 214 to different wavelength light to produce output light of desired color. In an embodiment, each of the wavelength-conversion regions 222 may be a thin layer of materials, e.g., less than one hundred (100) microns, coated onto the surface of one of the semispherical depressions 222. In this embodiment, the photoluminescent material of the wavelength-conversion regions 222 may be mixed with another material such as silicone, epoxy, glass, a hybrid of silicone and epoxy and UV curable epoxy. In an alternative embodiment, each of the wavelength-conversion regions 222 may be a portion of the molded encapsulation plate 216 in which the photoluminescent material is embedded. In either embodiment, the wavelength-conversion regions 222 may or may not also include UV inhibitor to prevent the degradation of the regions from any UV light emitted from the light-emitting dies 214 or any external UV light. In an embodiment, the photoluminescent material of the wavelength-conversion regions 222 is selected to produce white light from the light emitted by the light-emitting dies 214 by absorbing some of the light emitted from the dies and converting it to longer wavelength light. The converted light and the original unconverted light combine to produce the desired white light.

The photoluminescent material of the wavelength-conversion regions 222 may include one or more different types of inorganic phosphors, one of more different types of organic phosphors, one or more different types of fluorescent organic dyes, one or more different types of hybrid phosphors, one or more different types of nano-phosphors, one or more different types of quantum dots or any combination of fluorescent organic dyes, inorganic phosphors, organic phosphors, hybrid phosphors, nano-phosphors and quantum dots. A hybrid phosphor is defined herein as a phosphor made of any combination of inorganic phosphors and organic phosphors or dyes. Quantum dots, which are also known as semiconductor nanocrystals, are artificially fabricated devices that confine electrons and holes. Quantum dots have a photoluminescent property to absorb light and re-emit different wavelength light, similar to non-quantum phosphors. However, the color characteristics of emitted light from quantum dots depend on the size of the quantum dots and the chemical composition of the quantum dots, rather than just chemical composition as non-quantum phosphors. Nano-phosphors have similar optical properties as conventional phosphors. However, nano-phosphors are smaller in size than conventional phosphors, but larger than quantum dots. The size of conventional phosphors is in the range of 1-50 microns (typically in the 1-20 micron range). The size of nano-phosphors is smaller than 1 micron, but larger than quantum dots, which may be a few nanometers in size.

The following are some examples of the phosphors that can be included in the photoluminescent material of the wavelength-conversion regions 222. If the light-emitting dies 214 include blue or green LED dies, the photoluminescent material can include yellow phosphor (YAG, TAG), red phosphor (SrS, ZnSe), or orange phosphor (ZnSeS) and green phosphor (SrGa2S4, BaGa4S7). If the light-emitting dies 214 include UV LED dies, the photoluminescent material can include red phosphor (SrS, ZnSe, CaS, (Zn, Cd)S, Mg4GeO5.5F:Mn4+, Y2O2S:Eu), green phosphor (SrGa2S4, BaGa4S7, ZnS) and blue phosphor (BaMg2Al16O27).

The open spaces provided by the spherical depressions 220 of the molded encapsulation plate 216 and the reflector cups 218 of the substrate 212 (if any) may be filled with a transparent filling material 223 having a refractive index that substantially matches the refractive index of the molded transparent encapsulation plate. As an example, if the molded encapsulation plate 216 has a refractive index of approximately 1.55, then the transparent filling material 223 may be epoxy. As another example, if the molded encapsulation plate 216 has a refractive index of approximately 1.7, then the transparent filling material 223 may be silicone. However, if the molded encapsulation plate 216 has a refractive index of approximately 1.5, then these spaces may not be filled with a transparent material but rather filled with air, which has a refractive index of 1.5.

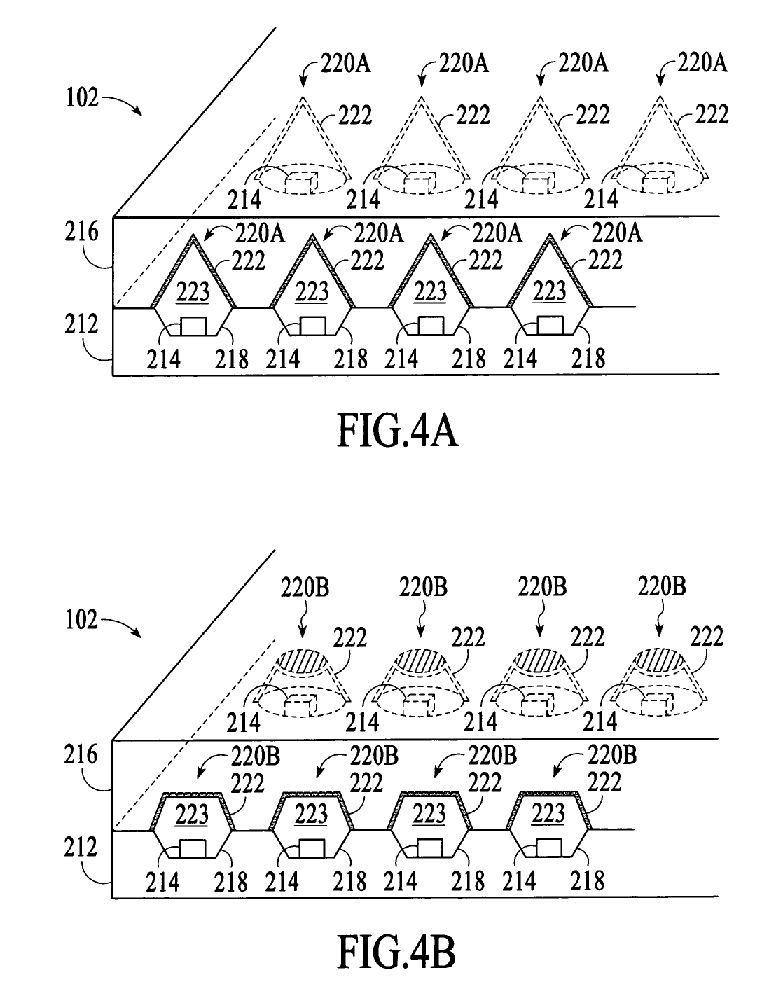

In alternative embodiments, the molded transparent encapsulation plate 216 may include other types of depressions. As shown in FIG. 4A, the molded encapsulation plate 216 in accordance with a first alternative embodiment may include conical depressions 220A, which have triangular cross-sectional shapes. As shown in FIG. 4B, the molded encapsulation plate 216 in accordance with a second alternative embodiment may include frusto-conical depressions 220B with grooves 224 on the top surfaces of the depressions. As an example, these grooves 224 may be V-shaped grooves. As shown in FIG. 4C, the molded encapsulation plate 216 in accordance with a third alternative embodiment may include frusto-conical depressions 220C with multiple facets 226, similar to the facets of a cut diamond, on the top surfaces of the depressions.

Turning now to FIG. 5, a backlight module 500 in accordance with another embodiment of the invention is described. In this embodiment, the backlight module 500 is an edge-side type backlight module. The components of the backlight module 500 are shown in FIG. 5, which is an exploded diagram of the module. In FIG. 5, the same reference numerals of FIG. 1 are used to indicate similar elements found in both FIGS. 1 and 5. The backlight module 500 includes a light source device 502, a V-shaped light guide panel 504, a reflective plate 528, the diffusion plate 106, the BEF 108 and the protective plate 110. In contrast to the light source device 102 of the backlight module 100 of FIG. 1, the light source device 502 of the backlight module 500 is positioned adjacent the wider side of the V-shaped light guide panel 504 to transmit light generated by the light source device 502 into the light guide panel 504. The light from the light source device 502 is then reflected off the reflective plate 528 toward the upper surface of the light guide panel 504 so that the light is emitted from the upper surface of light panel in a substantially uniform manner.

The light source device 502 of the backlight module 500 is similar to the light source device 102 of the backlight module 100 of FIG. 1. However, the light source device 502 includes fewer rows of light-emitting dies 214. As an example, the light source device 502 may include only a single row of light-emitting dies 214. Thus, the light source device 502 can be much narrower than the light source device 102. The light source device 502 includes the substrate 212 with or without the reflector cups 218, as illustrated in FIGS. 2 and 3. Furthermore, the light source device 502 includes the molded transparent encapsulation plate 216 with the depressions 220 on the lower surface. These depressions 220 may be semispherical 220A, conical 220B or frusto-conical 220C in shape with grooves 424 or multiple facets 426 on the upper surfaces of the depressions, as illustrated in FIGS. 4A-4C.

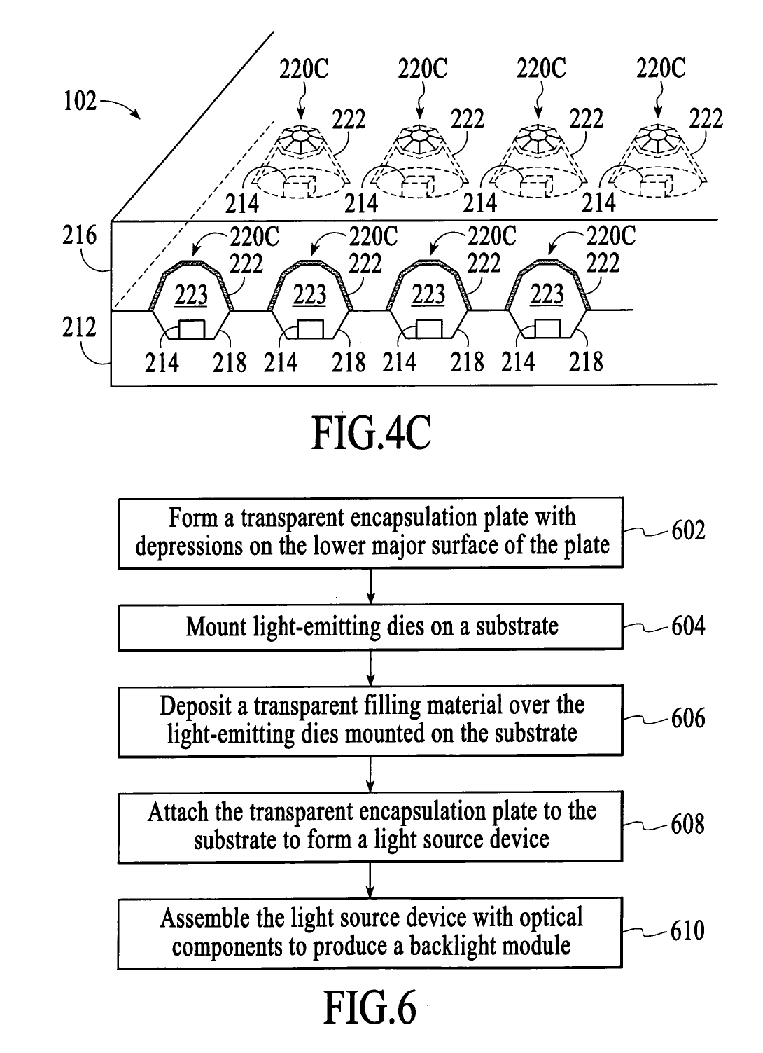

A method for making a backlight module in accordance with an embodiment of the invention is described with reference to FIG. 6. At block 602, a transparent encapsulation plate with depressions on a lower major surface of the plate is formed. The transparent encapsulation plate may be formed using injection molding or other molding techniques suitable for the type of material used. Next, at block 604, light-emitting dies are mounted on a substrate. In an embodiment, the light-emitting dies are mounted on the substrate in reflector cups of the substrate. In an alternative embodiment, the light-emitting dies are mounted on a planar upper surface of the substrate, which does not have reflector cups. Next, at optional block 606, a transparent filling material is deposited over the light-emitting dies mounted on the substrate. Next, at block 608, the transparent encapsulation plate is attached to the substrate such that the depressions are positioned over the light-emitting dies mounted on the substrate to form a light source device of the backlight module. Next, at block 610, the backlight module is assembled with optical components, such as a light guide panel, a diffusion sheet and a BEF, to produce the backlight module.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A backlight module comprising:
a light panel; and
a light source device optically coupled to said light panel to transmit light into said light panel, said light source device comprising:
a substrate;
a plurality of light-emitting dies mounted on said substrate, said light-emitting dies being configured to generate original light; and
a transparent encapsulation plate over said substrate to encapsulate said light-emitting dies, said encapsulation plate including depressions on a surface facing said light-emitting dies, each of said depressions being positioned over at least one of said light-emitting dies.

2. The backlight module of claim 1 further comprising at least one wavelength-conversion region optically coupled to said light-emitting dies mounted on said substrate, said wavelength-conversion region including a photoluminescent material having a property to convert at least some of said original light into converted light.

3. The backlight module of claim 2 wherein said wavelength-conversion region is a layer of materials on a surface of one of said depressions.

4. The backlight module of claim 2 wherein said wavelength-conversion region is a portion of said encapsulation plate.

5. The backlight module of claim 2 wherein said photoluminescent material of said wavelength-conversion region includes at least one type of phosphor.

6. The backlight module of claim 1 wherein said depressions on said surface of said encapsulation plate include semispherical depressions.

7. The backlight module of claim 1 wherein said depressions on said surface of said encapsulation plate include conical depressions.

8. The backlight module of claim 1 wherein said depressions on said surface of said encapsulation plate include frusto-conical depressions.

9. The backlight module of claim 8 wherein said frusto-conical depressions includes grooves on surfaces of said frusto-conical depressions.

10. The backlight module of claim 8 wherein said frusto-conical depressions include facets on surfaces of said frusto-conical depressions.

11. The backlight module of claim 1 further comprising at least one of a diffusion plate and a Brightness Enhancement Film.

12. The backlight module of claim 1 wherein said light source device is positioned adjacent to a major surface of said light panel.

13. The backlight module of claim 1 wherein said light source device is positioned adjacent to a side surface of said light panel.

14. A method of making a backlight module, said method comprising:
forming a transparent encapsulation plate with depressions on a major surface of said transparent encapsulation plate;
mounting light-emitting dies on a substrate;
attaching said transparent encapsulation plate to said substrate such that said depressions are positioned over said light-emitting dies mounted on the substrate to form a light source device of said backlight module; and
assembling said backlight module with at least one optical component to produce said backlight module.

15. The method of claim 14 wherein said forming said transparent encapsulation plate includes creating at least one wavelength-conversion region, said wavelength-conversion region including a photoluminescent material.

16. The method of claim 15 wherein said creating said at least one wavelength-conversion region includes depositing a layer of materials on a surface of one of said depressions.

17. The method of claim 15 wherein said creating said at least one wavelength-conversion region includes embedding said photoluminescent material into said encapsulation plate.

18. The method of claim 14 wherein said forming said transparent encapsulating plate includes forming said transparent encapsulation plate with semispherical depressions, conical depressions or frusto-conical depressions.

19. The method of claim 18 wherein said frusto-conical depressions include grooves or facets on surfaces of said frusto-conical depressions.

20. The method of claim 14 wherein said assembling includes assembling said light source device with at least one of a diffusion plate and a Brightness Enhancement Film to produce said backlight module.
